(19) United States
(12) Patent Application Publication
(10) Pub. No.: US 2014/0255088 A1
(43) Pub. Date: Sep. 11, 2014

(54) BODYWORK COMPONENT

(71) Applicant: Ford Global Technologies, LLC, Dearborn, MI (US)

(72) Inventor: Darko DRAZIC, Roesrath (DE)

(73) Assignee: Ford Global Technologies, LLC, Dearborn, MI (US)

(21) Appl. No.: 14/195,380

(22) Filed: Mar. 3, 2014

(30) Foreign Application Priority Data
Mar. 5, 2013 (DE) 10 2013 203 714.7

(51) Int. Cl. B62D 27/02

(52) U.S. Cl. CPC B62D 27/026
USPC 403/267

(57) ABSTRACT

A bodywork component for a vehicle, in particular for a motor vehicle, having an inner portion and an outer portion which are connected to each other at least in part-regions by means of an edge-side folded/bonded connection. An edge-side projection of the outer portion is folded over an edge region of the inner portion. There is intended to be provided a measure which prevents undesirable discharge of adhesive on folded bodywork components in an absolutely reliable manner. This is achieved in that the edge region of the inner portion is provided with a plurality of cutouts which are arranged with spacing from each other and which form hollow spaces as receiving pockets for excess adhesive.

### CROSS-REFERENCE TO RELATED APPLICATIONS

This application claims foreign priority benefits under 35 U.S.C. §119(a)-(d) to DE 10 2013 203 714.7 filed Mar. 5, 2013, which is hereby incorporated by reference in its entirety.

### TECHNICAL FIELD

The invention relates to a bodywork component for a vehicle, in particular for a motor vehicle, having an inner portion and an outer portion which are connected to each other at least in part-regions by means of an edge-side folded/bonded connection, wherein there is provided at the outer portion an edge-side projection which is folded over the edge region of the inner portion.

### BACKGROUND

In a large number of structural components of a motor vehicle, such as, doors, hoods, rear flaps, luggage space covers, among others, a connection of the outer portion and inner portion of the structural component is produced by means of a folding operation using an adhesive there between. In this instance, adhesive is first applied to the outer portion which generally comprises sheet metal. In the next operating step, the inner portion is fitted into the outer portion. Subsequently, the inner portion is aligned with respect to the outer portion and the two components are fixed relative to each other. In the subsequent folding operation, the outer portion is folded around the inner portion and a folded/bonded connection of the two portions is produced.

Various process fluctuations and other influences often lead to the adhesive between the inner portion and the outer portion being distributed in a non-uniform manner and being partially squeezed from the folded connection. Unclean edge regions which require a finishing operation during production may thereby be required.

The existing problem has already been recognized by different manufacturers, and attempts have been made for a long time to provide an appropriate remedy.

In a known bodywork component of the type mentioned in the introduction (DE 101 15 282 A1) there are formed in the edge region of the inner portion a plurality of knob-like stamped portions which are spaced apart from each other and which are raised in the direction towards the outer portion and which form in the fitted state of the inner portion and outer portion a defined gap dimension between the inner portion and outer portion. Although this design provides for receiving space for the adhesive, an undesirable discharge of adhesive is not reliably prevented.

In another known bodywork component (DE 10 2005 033 751 A1) there is applied to the inner portion a continuous stamped portion which is orientated in the direction towards the fold of the outer portion and which moves into abutment therewith at the end of the folding operation. By means of the continuous stamped portion which acts in the manner of a barrier, the adhesive is intended to be prevented from expanding towards the outer side. This measure may be a step in the right direction but, in spite of this barrier, which is effective only immediately before the end of the folding operation, adhesive cannot be reliably prevented from being discharged towards the outer side during the folding operation in an undesirable manner.

### SUMMARY

Therefore, an object of this disclosure is to provide a measure which reliably prevents undesirable discharge of adhesive at folded bodywork components.

In one aspect of the disclosure an edge region of an inner portion is provided over an entire length of a folded/bonded connection or over part-regions of the folded/bonded connection. A plurality of cutouts are provided which are arranged with spacing from each other and which form hollow spaces as receiving pockets for excess adhesive.

In this aspect, the cutouts provide structurally produced hollow spaces in which the excess adhesive can expand so that undesirable discharge of the adhesive from the folded connection is effectively prevented. In one embodiment, the cutouts may extend along the entire folded/bonded connection. In another embodiment, when the discharge of adhesive may be a problem only in regions along the folded/bonded connection, the cutouts may extend over only specific regions of the folded/bonded connection. The remaining edge regions of the inner portion which also belong to the folded/bonded connection, may have no cutouts.

The cutouts provided at the edges of the inner portion may have different geometric shapes.

The cutouts may be constructed as rectangular or triangular cutouts. The cutouts may also be constructed in a curved manner, for example, in the form of a circle segment, preferably as a semicircular face.

Alternatively, the cut edge geometry may also be constructed in an undulating manner, the wave troughs forming the receiving pockets for the excess adhesive.

The quantity of the adhesive used for the folded/bonded connection is advantageously metered in such a manner that the hollow spaces formed by the cutouts are only partially filled with adhesive during the folding operation. It is thereby reliably ensured that any excess adhesive flows into the hollow spaces, which act as receiving pockets, and is inhibited from discharged beyond the cutouts and out of the fold.

Sheet metal may be used as the material for the outer portion, for example, steel, aluminum or magnesium sheet which are very suitable for the formation of folds. The inner portion, in the same manner as the outer portion, may also be constructed as a metal sheet. The inner portion may also be constructed as a die-cast component, in particular of aluminum or magnesium, or a non-metal sheet such as a plastics component. Examples of plastics materials for the inner portion include composite materials which contain carbon and glass fibers.

The invention is illustrated by way of example in the drawings and described in detail below with reference to the drawings, in which:

### BRIEF DESCRIPTION OF THE DRAWINGS

FIG. 1 is a plan view of an inner portion and an outer portion in an unfolded state.

FIG. 2 is a section along the line II-II of FIG. 1.

FIG. 3 is a plan view of the inner and outer portion in a folded state.

FIG. 4 is a section along the line IV-IV from FIG. 3.

FIG. 5 is a similar plan view as FIG. 1 with a modified geometry of the cutouts,

FIG. 6 is a similar plan view as FIG. 1 with another modification of the geometry of the cutouts.

FIG. 7 is a similar plan view as FIG. 1 with a fourth geometric embodiment of the cutouts.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

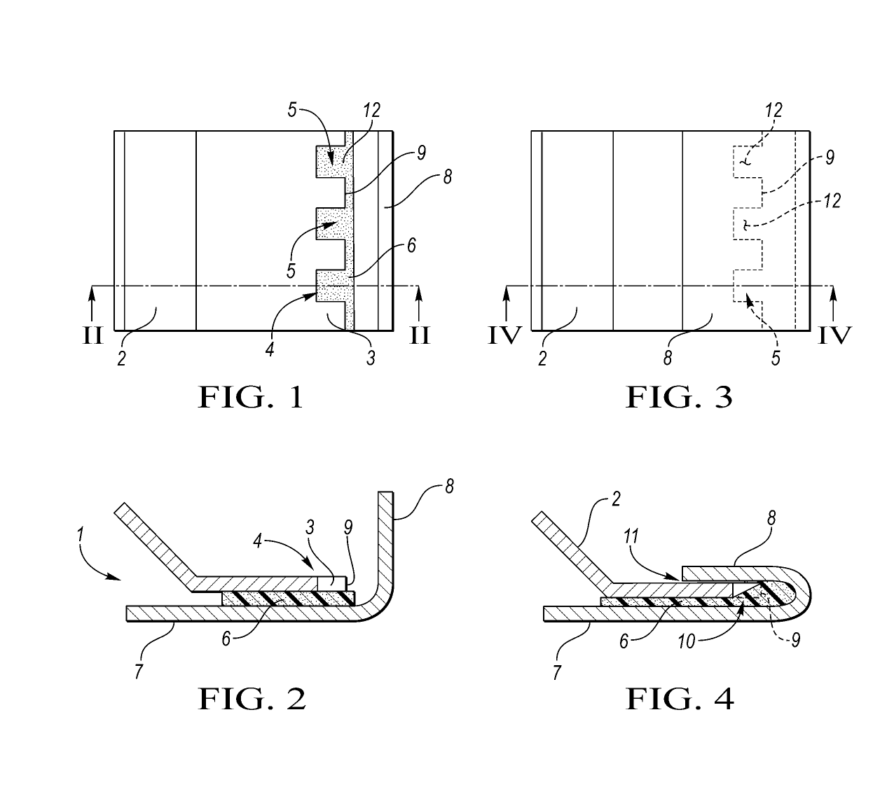

In a first embodiment illustrated in FIGS. 1 to 4, a multi-component bodywork component 1, which may be provided for a motor vehicle, comprises an inner portion 2 and an outer portion 7. The two components 2 and 7 are connected to each other in the edge region thereof by means of a combined folded/bonded connection at least in part-regions in a secure and permanent manner.

As can be seen in particular in the sectioned drawing according to FIG. 2, the outer portion 7 has an edge-side projection 8. This projection 8 is folded over the edge region 3 of the inner portion 2 in order to produce the connection.

In order to produce the folded/bonded connection, adhesive 6 is first applied to the outer portion 7 in the region shown in FIG. 2. In the next operating steps, the inner portion 2 is then fitted into the outer portion 7 and the two portions are subsequently aligned with respect to each other and fixed relative to each other. During the subsequent folding operation, the projection 8 of the outer portion 7 is folded around the inner portion 2 and the folded/bonded connection is thereby produced, the adhesive 6 may expand in both directions.

As can be seen in particular in FIG. 1, the edge region 3 of the inner portion 2 has cutouts 4 which are constructed according to FIG. 1 as rectangles and which form hollow spaces 5 for receiving the adhesive 6.

As illustrated in FIG. 4, the adhesive 6 expands, on the one hand, to the left in the direction towards the inner space between the inner portion 2 and the outer portion 7 and, on the other hand, to the right and then around the front edge 9 of the inner portion 2 in the direction towards the outer region 11. During this movement, the adhesive 6 flows partially around the front edge 9 of the edge region 3 of the inner portion 2 and reaches mainly the hollow spaces 5 which are formed by the cutouts 4 and which act as receiving pockets for the adhesive 6.

The quantity of the adhesive 6 is metered during application to the outer portion 7 in such a manner that the hollow spaces 5, which act as receiving pockets, are only partially filled with adhesive 6 during the folding and pressing operation. The partial filling of the hollow spaces 5 is illustrated in particular in FIG. 4 by the reference numeral 10. As a result of this structural embodiment of the edge region 3 of the inner portion 2 and the predetermined metering of the quantity of adhesive, a discharge of the adhesive in the direction towards the outer region 11 is prevented. Even when, owing to process fluctuations or other influences, the adhesive 6 is distributed in a non-uniform manner between the inner portion 2 and the outer portion 7, and an excess of adhesive is thereby produced where applicable in part-regions of the folded/bonded connection, the measures according to the invention are sufficient to prevent undesirable discharge of the adhesive from the fold.

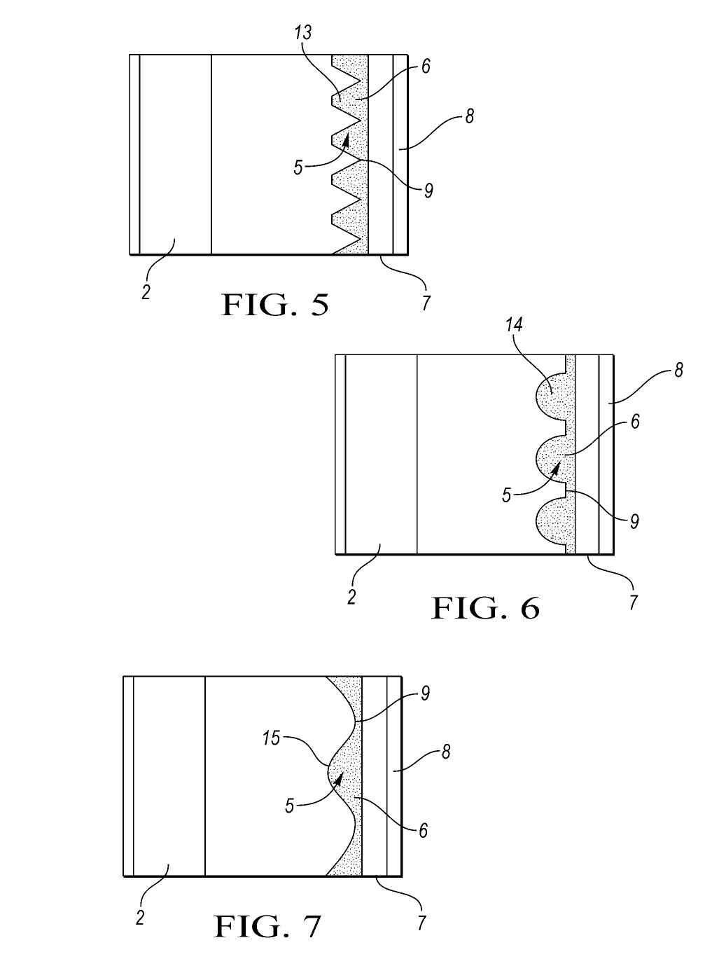

Other variants of the cutouts 4 in the edge region 3 of the inner portion 2 are illustrated in FIGS. 5 to 7.

In the embodiment illustrated in FIG. 5, the cutouts 4 which form the hollow spaces are constructed in a substantially triangular manner.

In the embodiment according to FIG. 6, the cutouts 4 which form the hollow spaces 5 are in the form of circle portions or circle segments 14, preferably in the form of a semi-circular face.

In the embodiment illustrated in FIG. 7, the edge region 3 of the inner portion 2 is constructed in an undulating manner, the recessed wave troughs 15 forming the hollow spaces 5 which act as receiving pockets for the adhesive 6.

In addition to the four embodiments described, other geometric constructions of the edge region 3 of the inner portion 2 are possible, it only having to be ensured that the edge region has specific cutouts which form hollow spaces for receiving the adhesive so that excess adhesive 6 can expand therein and consequently undesirable discharge of the adhesive in an outward direction from the fold connection may be prevented.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A bodywork component for a vehicle comprising;
an inner portion and an outer portion connected to each other at least in part-regions by an edge-side folded/bonded connection, wherein there is provided at the outer portion an edge-side projection that is folded over an edge region of the inner portion; and
wherein the edge region of the inner portion defines a plurality of cutouts that are arranged with spacing from each other and form hollow spaces as receiving pockets for excess adhesive.

2. The bodywork component of claim 1, wherein the cutouts are rectangular.

3. The bodywork component of claim 1, wherein the cutouts are triangular.

4. The bodywork component of claim 1, wherein the cutouts are constructed in a curved manner.

5. The bodywork component of claim 4, wherein the cutouts are in the form of a circle segment.

6. The bodywork component of claim 5, wherein the circle segment is in the form of a semicircular face.

7. The bodywork component of claim 1, wherein the cutouts are defined by wave troughs of an undulating edge region.

8. The bodywork component of claim 1, wherein a quantity of the adhesive is metered in such a manner that the hollow spaces formed by the cutouts are at least partially filled with adhesive during the folding of the outer portion over the inner portion.

9. The bodywork component of claim 1, wherein the outer portion comprises sheet metal.

10. The bodywork component of claim 9, wherein the inner portion comprise sheet metal.

11. A bodywork component comprising:
an inner portion having an edge region with cutouts defining hollow spaces;
an outer portion having an edge-side projection folded over the edge region of the inner portion extending to an outer region; and
an adhesive disposed between the inner and outer portions at least partially filling the hollow spaces, wherein discharge of the adhesive past the outer region is prevented.

12. The bodywork component of claim 11, wherein the cutouts are rectangular.

13. The bodywork component of claim 11, wherein the cutouts are triangular.

14. The bodywork component of claim 11, wherein the cutouts are semicircular.

15. A bodywork component for a vehicle comprising:
an inner portion having an edge region extending to a front edge, the edge region defining hollow spaces along the front edge;
an outer portion having an edge-side projection folded over the edge region of the inner portion and extending to an outer region; and
an adhesive disposed between the inner and outer portions around the front edge of the inner portion and partially filling the hollow spaces.

16. The bodywork component of claim 15, wherein the adhesive does not extend past the outer region.

17. The bodywork component of claim 15 wherein the outer portion comprises aluminum.

18. The bodywork component of claim 15 wherein the inner portion comprises aluminum.

19. The bodywork component of claim 15 wherein the inner portion is a plastics component.

20. The bodywork component of claim 15 wherein the inner portion is a composite material comprising glass fibers.
